(19) United States
(12) Patent Application Publication
(10) Pub. No.: US 2020/0178479 A1
(43) Pub. Date: Jun. 11, 2020

(54) Hillside Planter Dam

(71) Applicant: Colleen Talbert, THOUSAND OAKS, CA (US)

(72) Inventor: Colleen Talbert, THOUSAND OAKS, CA (US)

(21) Appl. No.: 16/675,418

(22) Filed: Nov. 6, 2019

Related U.S. Application Data
(63) Continuation-in-part of application No. 29/689,462, filed on Apr. 30, 2019.
(60) Provisional application No. 62/778,073, filed on Dec. 11, 2018.

(51) Int. Cl. A01G 9/28

(52) U.S. Cl. CPC A01G 9/28

(57) ABSTRACT

A hillside planter dam enabling a user to cultivate plants on a sloped or otherwise irregular grade has an overhanging funnel, a lateral sidewall, a trowel portion, and a main axis. The overhanging funnel provides a flared structure suitable for gathering rainfall and directing the flow of said water to the interior of the lateral sidewall. The lateral sidewall defines a retention structure defined concentrically about the main axis, terminating in the trowel portion opposite the overhanging funnel. The trowel portion defines an edged formation tapering from the lateral sidewall towards the main axis, wherein the trowel portion defines a similar overall form to a conventional gardening trowel. In at least one instance, a user may employ the hillside planter dam as both a hand tool and a fixed installation, wherein the overhanging funnel may be used as a handle to affect the placement of the trowel portion.

### FIELD OF THE INVENTION

The present invention relates generally to the field of home-gardening and small-scale horticulture. Specifically, the present invention relates to a tool and implement useful for situation plants on an otherwise unplantable slope or grade. Further, the present invention contemplates specific structures suitable for supporting plant growth in arid environments characterized by minimal rainfall and porous topsoil.

### BACKGROUND OF THE INVENTION

Home gardening, both as a hobby and a means of enhancing curb-appeal, is a well-known pastime and profession. Gardeners are also known to engage in small-scale agriculture; cultivating herb gardens, small vegetable plantations, or other consumable plants to subsidize and improve the availability of fresh produce. However, areas used for planting are presently required to comprise flat, non-porous tracts of land to maintain high moisture content and allow any sprouts to root properly without being eroded by water flowing downhill. This limitation may be addressed by significant re-grading or landscaping of an area, either to flatten or steppe the planting zones, but such measures are recognized as being prohibitively expensive or otherwise impractical in many scenarios involving small-scale plantations. It is therefore recognized that a means of fixing and supporting individual plants into a sloped grade is desirable and presently absent from the market today.

The hillside planter dam relates generally to the horticultural and gardening equipment developed to enable planting on severe slopes or other locations wherein conventional means and methods are insufficient to enable long-term sustainable growth. More specifically, the present invention is a combined water retention barrier and with an integral earthmoving tool, offering an individual expanded utility beyond a simple trowel or basic inset barrier combining functional features of both into a single, novel configuration. It is further considered that the hillside planter dam will feature a means of improving rainwater collection and retention, simultaneously serving to prevent precipitation-caused erosion of the downslope terrain of an installed unit and enhancing the capacity of a supported plant to grow. Specific structures of the hillside planter dam are further contemplated to serve double functions as ergonomic grasping points, facilitating the use of the hillside planted dam in a manner similar to a generic trowel tool. The tool-end of the hillside planter dam is further contemplated to be suitable for extended burial, supporting the aboveground portions of the hillside planter dam when in a fixed configuration.

### BRIEF DESCRIPTION OF THE DRAWINGS

FIG. 1 is a top-front-left perspective view of the present invention.

FIG. 2 is a bottom-right-rear view of the present invention.

FIG. 3 is a left-side elevational view of the present invention.

FIG. 4 is a bottom plan view of the present invention.

FIG. 5 is a left-side elevational view of the present invention, wherein portions of the present invention have been removed to demonstrate construction.

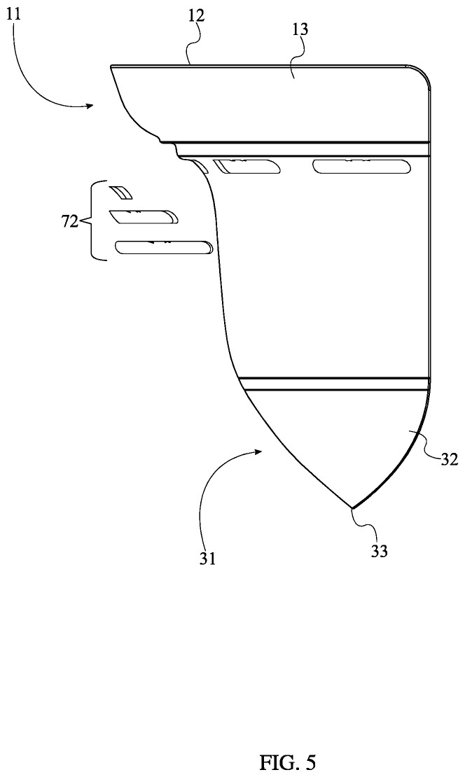

FIG. 6 is a detail view of area 6 of FIG. 3.

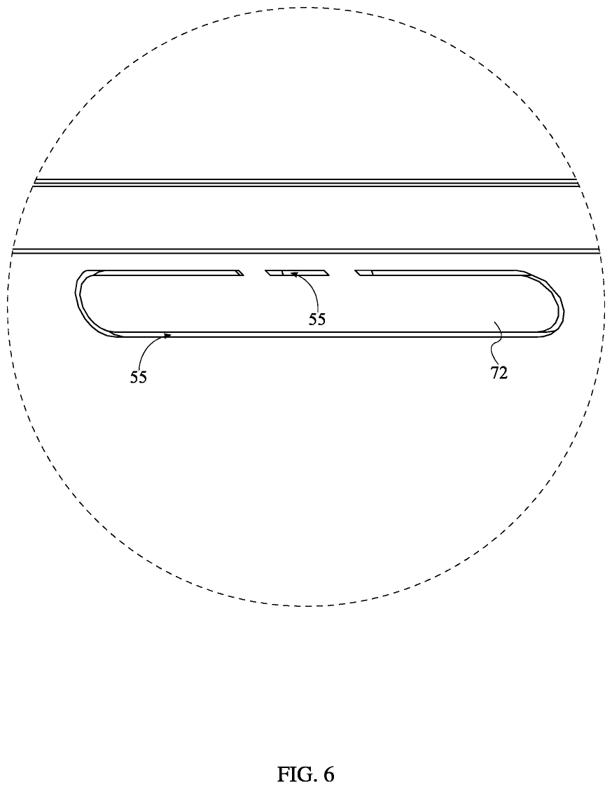

### DETAIL DESCRIPTIONS OF THE INVENTION

All illustrations of the drawings are for the purpose of describing selected versions of the present invention and are not intended to limit the scope of the present invention.

The hillside planter dam relates generally to the horticultural and gardening equipment developed to enable planting on severe slopes or other locations wherein conventional means and methods are insufficient to enable long-term sustainable growth. More specifically, the present invention is a combined water retention barrier and integral earthmoving tool, offering an individual expanded utility beyond a simple trowel or basic inset barrier combining functional features of both into a single, novel configuration. It is further considered that the hillside planter dam will feature a means of improving rainwater collection and retention, simultaneously serving to prevent precipitation-caused erosion of the downslope terrain of an installed unit and enhancing the capacity of a supported plant to grow. Specific structures of the hillside planter dam are further contemplated to serve double functions as ergonomic grasping points, facilitating the use of the hillside planted dam in a manner similar to a generic trowel tool. The tool-end of the hillside planter dam is further contemplated to be suitable for extended burial, supporting the aboveground portions of the hillside planter dam when in a fixed configuration.

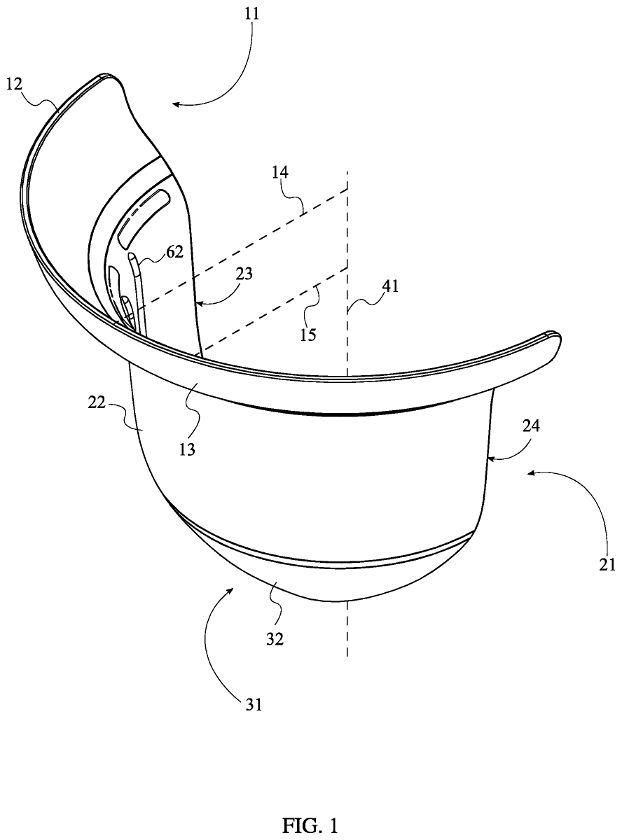

In reference to FIG. 1, the present invention is a hillside planter dam that is used to enable and support plant growth in unconventional sloped areas. To accomplish this, the present invention comprises an overhanging funnel 11, a lateral sidewall 21, a trowel portion 31, and a main axis 41. The overhanging funnel 11 is a flared non-porous body configured to capture and direct rainwater to an interior section of the lateral sidewall 21. The lateral sidewall 21 is a contoured intermediary body enabling the present invention to retain a volume of topsoil on an upslope side of the installed unit. The trowel portion 31 is a distal, angular portion of the hillside planter dam serving as both an earthmoving tool and as a stationary stake when driven into the ground. The main axis 41 is a linear path defining the concentric axis about which the curvature of the overhanging funnel 11, the lateral sidewall 21, and the trowel portion 31 may be drawn. The overall configuration of the aforementioned components allows the present invention to define a rigid, impermeable fixture supporting a plant in-position on a steep grade that would otherwise be infeasible.

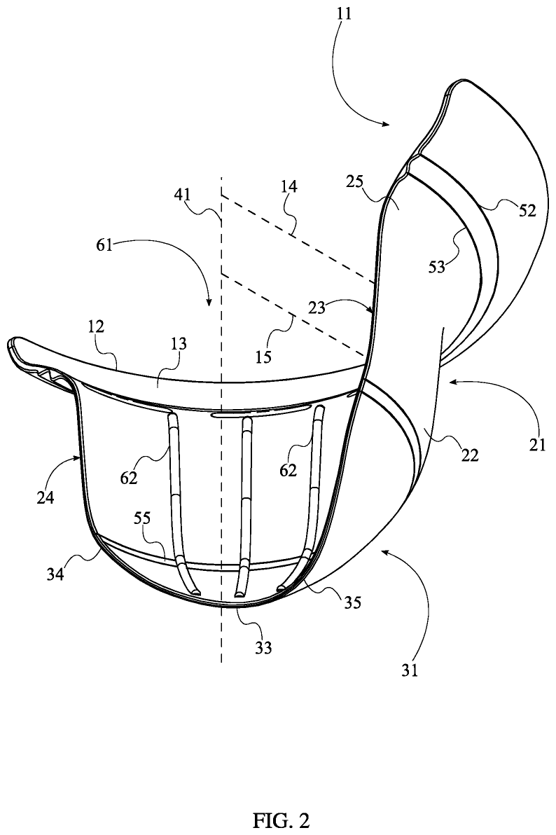

In reference to FIG. 2, the trowel portion 31 comprises a trowel blade 32, an intermediary cutting edge 33, a first cutting edge 34, and a second cutting edge 35. The trowel blade 32 is a rigid, impermeable surface defining the main body of the trowel portion 31. The intermediary cutting edge 33, first cutting edge 34, and second cutting edge 35 are rigid, sharpened structures delineating the trowel blade 32 and defining the distal facets of the trowel portion 31. This configuration enables the trowel portion 31 to effectively penetrate the ground with the intermediary cutting edge 33, the first cutting edge 34, and the second cutting edge 35, and lift a volume of soil upon the trowel blade 32. The lateral sidewall 21 comprises a sidewall body 22, a first lateral edge 23, and a second lateral edge 24. The sidewall body 22 defines an intermediary structure connecting the trowel portion 31 and the overhanging funnel 11 to form a substantially rigid assembly. This connection defines the contiguous form of the hillside planter dam as previously described, while the first lateral edge 23 and the second lateral edge 24 offer torsional support parallel to the main axis 41. Specifically, the first lateral edge 23 and the second lateral edge 24 delineate the sidewall body 22 parallel to the main axis 41. The overhanging funnel 11 further comprises a rim 12. The rim 12 is the outermost concentric feature of the hillside planter dam positioned at the distal edge of the overhanging funnel 11. The rim 12 is contemplated to be concentric to the main axis 41 in order to maintain the overall structure of the overhanging funnel 11 to retain the fluid-capturing qualities described above. The trowel blade 32 is ideally offset from the main axis 41 by an acute angle. The projected intersection of the trowel blade 32 and the main axis 41 will provide a tapered leading profile considered to provide a suitable structure with which to scoop topsoil or other material. The taper of the trowel blade 32 is further considered to provide superior planar rigidity compared to regular cylindrical examples. The intermediary cutting edge 33 is positioned opposite the sidewall body 22, across the trowel blade 32. This arrangement will enable a user to drive the intermediary cutting edge 33 into the ground, forcing any lifted soil across the trowel blade 32 and into the sidewall body 22. The first cutting edge 34 is connected in between the first lateral edge 23 and the intermediary cutting edge 33, the second cutting edge 35 is connected between the second lateral edge 24 and the intermediary cutting edge 33, and the first cutting edge 34 is opposite the second cutting edge 35 opposite the intermediary cutting edge 33. In this configuration, it is understood that the first lateral edge 23, the first cutting edge 34, the intermediary cutting edge 33, the second cutting edge 35, and the second lateral edge 24 for a continuous feature of the hillside planter dam. This contiguous feature will enable the user to force the trowel portion 31 and sections of the sidewall body 22 into the ground without encountering any stoppage due to irregular protrusions on the distal edges of the hillside planter dam.

Referring to FIGS. 1 and 2, the present invention further comprises the overhanging funnel 11 further comprises a funnel body 13. The funnel body 13 constitutes an impermeable, semi-flexible canopy surface extending inwards from the rim 12 to the sidewall body 22. Specifically, the rim 12 is positioned opposite to the lateral sidewall 21 across the funnel body 13 and the funnel body 13 tapers from the rim 12 toward the lateral sidewall 21. This structure is considered suitable to gather and redirect water falling from above an installed unit, specifically preventing rainfall from eroding the volume of soil downslope of the hillside planter dam and compromising the planting position. It is further considered that any water gathered in this way will flow down the tapered structure of the funnel body 13 to be absorbed by a plant associated with the hillside planter dam.

In the ideal embodiment of the present invention, a radius 14 of the rim 12 is greater than a maximum radius 15 of the lateral sidewall 21. This relation ensures that the funnel body 13 of the overhanging funnel 11 will always be positioned to increase the exposed surface area of an installed hillside planter dam, gathering more rainfall and protecting more downslope soil than an iteration with a straight funnel body 13.

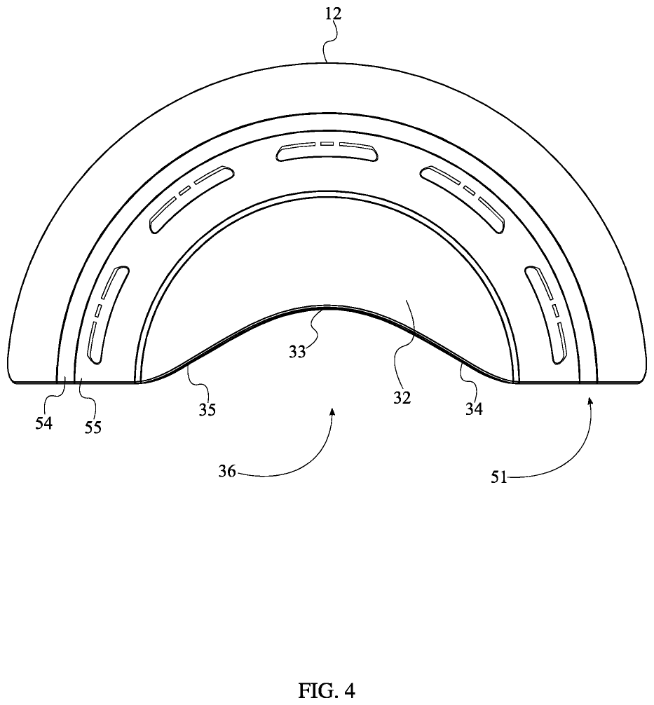

In reference to FIGS. 2 and 4, some embodiments of the present invention further comprise a radial support member 51. The radial support member 51 constitutes a raised, thickened, or otherwise reinforced feature of the hillside planter dam that is connected between the lateral sidewall 21 and the funnel body 13. The additional material thickness offered by the radial support member 51 is contemplated to provide lateral structural rigidity to the overall structure of the hillside dam planter.

Further embodiments of the hillside planted dam further comprise a first mounting edge 52 and a second mounting edge 53. The first mounting edge 52 defines a protrusion of material traversing the perimeter of the hillside planter dam, opposite the rim 12 across the overhanging funnel 11. The second mounting edge 53 defines a similar radial protrusion to the first mounting edge 52 positioned opposite to the trowel portion 31 across the lateral sidewall 21. The radial support member 51 is additionally considered to comprise a shelf 54 and a support band 55. The shelf 54 is connected adjacent to the overhanging funnel 11, coextensive to the first mounting band. Further, the shelf extends perpendicularly away from the overhanging funnel. This arrangement provides further structural support to the overhanging funnel 11 via material support of a critical juncture between the overhanging funnel 11 and the lateral sidewall 21. The present arrangement is also considered to be effective in providing a physical backstop and visual reference with which the user may fix the hillside planter dam into the ground at a desired depth. The support band 55 is similarly contemplated to be formed adjacent and coextensive to the second mounting edge 53, opposite the first mounting edge 52. This formation is contemplated to lend additional material support to a high-stress region of the hillside planter dam, in conjunction with the first mounting band, to ensure that the overhanging funnel 11 and the lateral sidewall 21 will not bend or deflect when being used as a hand trowel.

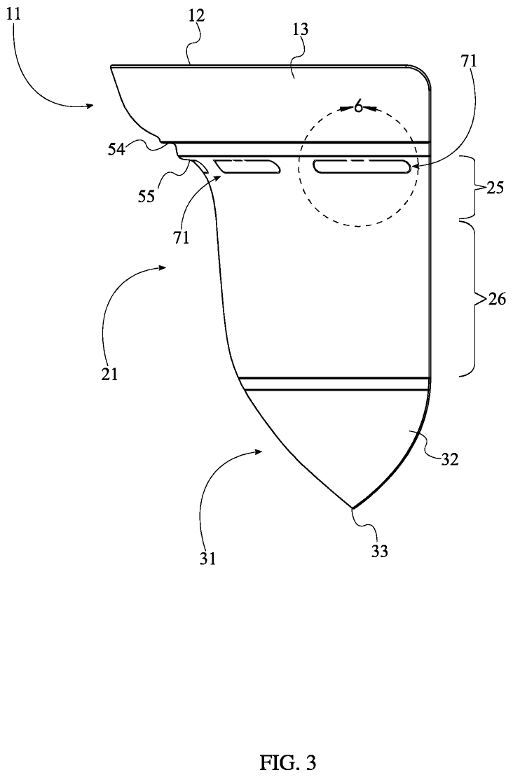

In reference to FIGS. 3 and 4 the hillside planter dam further comprises a plant-receiving compartment 61 primarily delineated by the sidewall body 22. The plant-receiving compartment 61 is contemplated to partially enclose a bulb, pod, sprout, or mature plant within the hillside planter dam. The sidewall body 22 further comprises a curved portion 25 and an intermediary portion 26, wherein the curved portion 25 defines a structural taper between the overhanging funnel 11 and the intermediary portion 26. This taper provides a clear path for water to flow down from the overhanging funnel 11, ultimately leading to a suitable narrow tip useful for digging on the trowel portion 31. The curvature of the curved portion 25 is further considered to laterally bracket the plant-receiving compartment 61 to prevent the outflow of water or topsoil from the area upslope of an installed hillside planter dam. The intermediary portion 26 defines the area between the curved portion 25 and the trowel portion 31, constituting a lateral and transverse taper as the lateral sidewall 21 transitions to the trowel portion 31.

In at least one contemplated embodiment of the present invention, the plant-receiving compartment 61 may be collectively delineated by the overhanging funnel 11, the lateral sidewall 21, and the trowel portion 31. A plurality of support ribs 62 is mounted adjacent to the lateral sidewall 21 and the trowel portion 31 in this embodiment, within the plant-receiving compartment 61. Further, the plurality of support ribs 62 is distributed across the sidewall body 22, each of the plurality of support ribs 62 traversing from the sidewall body 22 toward the trowel blade 32. The plurality of support ribs 62 ideally constitutes raised sections of a similar material to the composition of the sidewall body 22, but it is understood that the material composition of the plurality of support ribs 62 or the hillside planter dam in general may vary in conceivable alternate embodiments. This plurality of support ribs 62 offers increased rigidity to the lateral sidewall 21 and the trowel portion 31 by bracing the largest planar axis of both areas with thickened material formations resistant to perpendicular deformation. This benefits a user during any attempts to use the hillside planter dam as an earthmoving tool, wherein the hillside planter dam may otherwise twist, bend, or otherwise deflect from a natural shape.

It is further considered that the plurality of support ribs 62 within the plant-receiving compartment 61 may constitute a static baffle system. Specifically, that the plurality of support ribs 62 may be arranged and formed to delay the passage of water about the interior of the plant-receiving compartment 61 to increase the availability of water to any plant contained therein. This feature is particularly desirable to users in particularly arid conditions or to counteract the drainage and loss of water through loose or granular topsoil.

Further embodiments of the hillside planter dam comprise a root-outlet hole 36 formed adjacent to the plant-receiving compartment 61. The root-outlet hole 36 will ideally traverse the trowel blade 32 at a position partially delineated by the intermediary cutting edge 33. This gap in the hillside planter dam will permit a plant supported within the plant-receiving compartment 61 to grow beyond the limits of the hillside planter dam to seek additional nutrients and naturally anchor to the surrounding terrain via a more extensive root network.

The hillside planter dam may further comprise at least one drainage aperture 71 integral to the lateral sidewall. The drainage aperture 71 will provide a means of surface water to escape the plant-receiving compartment 61 to prevent any plants supported therein from being swamped by an accumulation of runoff water. This functionality enables the installation of the hillside planter dam in more conventionally verdant climates, wherein the frequent rainfall may not necessitate the maximal retention of fluid provided by the hillside planter dam. The drainage aperture 71 individually comprises a plate 72 and a plurality of perforations 73, wherein the plate in contiguous with the lateral sidewall. The plurality of perforations 73 substantially delineates the perimeter of the plate 72, traversing the lateral sidewall 21 such that the plate 72 may be detached from the hillside planter dam by a user by breaking the lateral sidewall 21 along the plurality of perforations 73. Specifically, the plate 72 is contemplated to be a frangible element that may be intentionally broken away from the lateral sidewall 21 to expose the full diameter of the drainage aperture 71. In various applications and installations it is contemplated that a user may expose at least one drainage aperture 71 to achieve a desired rate of water retention suitable for a given climate, average rainfall, soil condition, and type of supported plant.

Although the invention has been explained in relation to its preferred embodiment, it is to be understood that many other possible modifications and variations can be made without departing from the spirit and scope of the invention as hereinafter claimed.

What is claimed is:

1. A hillside planter dam comprising:
an overhanging funnel;
a lateral sidewall;
a trowel portion;
a main axis;
the trowel portion comprising trowel blade, an intermediary cutting edge, a first cutting edge, and a second cutting edge;
the lateral sidewall comprising a sidewall body, a first lateral edge, and a second lateral edge;
the lateral sidewall being connected in between the overhanging funnel and the trowel portion;
the first lateral edge being positioned opposite to the second lateral edge across the sidewall body;
the main axis being concentrically aligned to a rim of the overhanging funnel;
the trowel blade being angularly offset from the main axis by an acute angle;
the intermediary cutting edge being positioned opposite to the sidewall body, across the trowel blade;
the first cutting edge being connected in between first lateral edge and the intermediary cutting edge;
the second cutting edge being connected in between the second lateral edge and the intermediary cutting edge;
the first cutting edge being positioned opposite to the second cutting edge, across the intermediary cutting edge;
the first lateral edge, the first cutting edge, the intermediary cutting edge, the second cutting edge, and the second lateral edge being a contiguous edge.

2. The hillside planter dam as claimed in claim 1 comprising:
the overhanging funnel comprising a funnel body;
the rim being positioned opposite to the lateral sidewall across the funnel body;
the funnel body tapering from the rim toward the lateral sidewall;

3. The hillside planter dam as claimed in claim 2, wherein a radius of the rim being greater than a maximum radius of the lateral sidewall.

4. The hillside planter dam as claimed in claim 1 comprising:
a radial support member;
the radial support member being connected in between the lateral sidewall and the funnel body;

5. The hillside planter dam as claimed in claim 4 comprising:
a first mounting edge;
a second mounting edge;
the radial support member comprising a shelf and a support band;
the first mounting edge being positioned opposite to a rim of the overhanging funnel, across the overhanging funnel;
the second mounting edge being positioned opposite to the trowel portion, across the lateral sidewall;
the shelf being connected adjacent to the overhanging funnel;
the shelf being positioned coextensive to the first mounting edge;
the shelf extending perpendicularly away from the overhanging funnel;
the support band being connected adjacent to the second mounting edge;
the support band being positioned coextensive to the second mounting edge;
the support band being connected to the shelf, opposite to the first mounting edge, across the lateral sidewall;

6. The hillside planter dam as claimed in claim 1 comprising:
the sidewall body comprising a curved portion and an intermediary portion;
the curved portion defining a structural taper between the overhanging funnel and the intermediary portion;
the intermediary portion being connected in between the curved portion and the trowel portion;

7. The hillside planter dam as claimed in claim 1 comprising:
a plant-receiving compartment;
a plurality of support ribs;
the plant-receiving compartment being delineated by the overhanging funnel, the lateral sidewall, and the trowel portion;
the plurality of support ribs being mounted adjacent to the lateral sidewall and the trowel portion;
the plurality of support ribs being positioned within the plant-receiving compartment;
each of the plurality of support ribs traversing from the sidewall body toward the trowel blade;
the plurality of support ribs being distributed across the sidewall body;

8. The hillside planter dam as claimed in claim 7 wherein the plurality of support ribs being a static baffle system;

9. The hillside planter dam as claimed in claim 1 comprising:
a root-outlet hole;
a plant-receiving compartment;
the root-outlet hole traversing through the trowel blade and into the plant-receiving compartment;
the root-outlet hole being partially delineated by the intermediary cutting edge;

10. The hillside planter dam as claimed in claim 1 comprising:
at least one drainage aperture;
the drainage aperture integrated into the lateral sidewall;

11. The hillside planter dam as claimed in claim 10 comprising:
the drainage aperture comprising a plate and a plurality of perforations;
the plate being contiguous to the lateral sidewall;
the plurality of perforations substantially delineating the perimeter of the plate;
the plurality of perforations traversing through the lateral sidewall;
